(19) United States
(12) Patent Application Publication
(10) Pub. No.: US 2009/0200715 A1
(43) Pub. Date: Aug. 13, 2009

(54) METHOD OF MANUFACTURING A STAVE COOLER FOR A METALLURGICAL FURNACE AND A RESULTING STAVE COOLER

(75) Inventors: Claude Pleimelding, Platen (LU); Nicolas Mousel, Dudelange (LU); Nicolas Maggioli, Thionville (FR)

Correspondence Address: CANTOR COLBURN, LLP, 20 Church Street, 22nd Floor, Hartford, CT, 06103, US

(73) Assignee: PAUL WURTH S.A., Luxembourg (LU)

(21) Appl. No.: 12/297,002

(22) PCT Filed: Mar. 21, 2007
(86) PCT No.: PCT/EP07/52680

§ 371 Date: Oct. 13, 2008

(30) Foreign Application Priority Data
Apr. 18, 2006 (EP) 06112730.4

(51) Int. Cl. C21B 7/10; B23K 20/00; B23K 28/00; B23P 17/04

(52) U.S. Cl. 266/241; 228/193; 228/101; 29/428

(57) ABSTRACT

A method of manufacturing a stave cooler for a metallurgical furnace including supplying a metal plate having an inward side for facing the inside of the furnace and an opposite outward side; supplying at least one coolant pipe; establishing a thermo-conductive contact between the coolant pipe and the metal plate; providing the coolant pipe with a flattened face and externally fixing the flattened face to the metal plate on the outward side for establishing the thermo-conductive contact.

### TECHNICAL FIELD OF THE INVENTION

The present invention generally relates to the field of cooling equipment for metallurgical furnaces such as blast furnaces. More precisely, the present invention concerns a method of manufacturing a stave cooler and a stave cooler manufactured with this method.

### BRIEF DESCRIPTION OF RELATED ART

Stave coolers, also called “staves”, have been used in blast furnaces for decades. They are arranged inside the furnace between the furnace shell and the refractory lining for cooling the latter and for protecting the former from the considerable process temperatures inside the furnace. In a very common design, they consist of a thick massive metal slab with several internal coolant channels extending through the slab and being integral with the slab. Connection pipe-ends to the internal channels are arranged on the rear side of the stave and lead out in a sealed manner through the furnace shell. The cooling channels of a plurality of staves are connected in series to a cooling water circuit of the furnace by means of these connection pipe-ends which lead out of the furnace shell.

Until some years ago, most staves in blast furnaces were cast iron staves. There are different methods for manufacturing such cast iron staves. According to a first method, a mould for casting the massive stave body is provided with one or more sand cores for forming the internal coolant channels. Liquid cast iron is then poured into the mould. This method has the disadvantage that the mould sand is difficult to remove from the cooling channels and/or that the cooling channel in the cast iron is often not properly formed or not tight enough. In order to avoid the aforementioned disadvantages, it has been suggested to arrange preformed steel pipes in the mould and to pour the liquid cast iron around the steel pipes. However, these cast iron staves with steel pipes have not proved satisfactory. Indeed, due to carbon diffusion from the cast iron into the steel pipes during the pouring, the latter become brittle and may crack. To avoid carbon diffusion, the pipes are usually coated. Such a coating considerably reduces the heat transfer between the stave body and the pipes.

As an alternative to cast iron staves, copper staves have been developed.

Different production methods have been proposed for copper stave coolers. Initially, an attempt was made to produce copper staves also by casting in moulds, the internal coolant channels being formed by a sand core in the casting mould. However, this method has not proved to be effective in practice, because the cast copper plate bodies often have cavities and porosities, which have an extremely negative effect on the life of the plate bodies. The mould sand is difficult to remove from the channels and the channel is often not properly formed.

A cooling plate made from a forged or rolled copper slab is known from DE 2 907 511. The coolant channels are blind holes introduced by deep drilling the rolled copper slab. The blind bores are sealed off by welding in plugs. Then, connecting bores to the blind bores are drilled from the rear side of the plate body. Thereafter, connection pipe-ends for the coolant feed or coolant return are inserted into these connecting bores and welded to the stave body. With these cooling plates, the above-mentioned disadvantages related to casting are avoided. In particular, cavities and porosities in the plate body are virtually precluded. The above manufacturing method is however relatively expensive both in labour and material. Furthermore, due to considerable mechanical and thermal stress to which the stave cooler is exposed, the different welded connection joints are critical as regards fluid tightness. In addition, since the channels are integral with the stave body, there is only one level of separation between the coolant and the furnace interior, i.e. if the stave body cracks open, coolant will leak. A leakage of coolant fluid into the furnace however leads to a significant risk of explosion and should therefore be avoided at all cost.

An alternative design of a stave-like cooling contrivance has been proposed in U.S. Pat. No. 4,071,230. This contrivance comprises a metal plate serving to shield the furnace shell on the interior side and several coolant pipes linked to the plate and attached to the furnace shell with their connection pipe-ends. The metal plate is longer in vertical direction than wide in horizontal direction and, in order to take up thermal dilatation, consists of several separate blocks, each block being in turn wider horizontally than long vertically. Furthermore, each block is provided with a set of grooves of circular cross-section for accommodating the pipes on the side facing the furnace shell. The circular grooves are lined with a layer of heat conductor. Each separate block also comprises means for fastening the block to the pipes. The pipes in turn have fasteners welded thereto for attaching the cooling contrivance to the furnace shell. Although the stave cooler according to U.S. Pat. No. 4,071,230 avoids the use of welded connection joints on the coolant pipes within the furnace shell, both material and labour costs for manufacturing these stave coolers are still considerable.

Another design of a stave-like cooling arrangement has been proposed in U.S. Pat. No. 4,559,011. This cooling arrangement comprises several spaced apart cooling pipes arranged in a frame and interconnected by welding with metallic tie plates. The interconnected pipes and tie plates are embraced by a metallic frame. For compensating thermal expansion, the tie plates, the fins as well as the walls of the frame have expansion slots or clearances. Each tie plate or pipe may be provided with fins on the side facing the furnace interior. The frame is filled with refractory material on the side facing the furnace interior in order to protect the whole cooling arrangement. Besides the considerable labour cost related to producing the stave type coolers according to U.S. Pat. No. 4,559,011, their use entails a certain risk of a coolant leakage into the furnace. In fact, once the refractory material has degraded and uncovered the pipes, the cooling pipes are exposed to abrasive wear by furnace gases and charge material (burden) and may leak therefore.

Yet another design of a stave-like cooling panel for blast furnaces has been described in GB 2 377 008. This cooling panel comprises a metal backing plate, to which are secured on the side facing the furnace interior, several metal cooling pipes. Each pipe has at least one projecting fin that is integrally formed with the pipe. The backing plate is preferably made of steel, whereas the pipes with integral fin(s) are preferably made of copper. The pipes may be fixed to the plate with an interfacing pad, e.g. made of aluminium bronze material. Although requiring less parts and assembly steps than the previous designs, the cooling panel remains expensive due to the required custom made pipes. Furthermore, with the cooling panels according to GB 2 377 008, the cooling pipes may also happen to be exposed to abrasive wear and the resulting leakage risk.

### BRIEF SUMMARY OF THE INVENTION

The invention provides a method for manufacturing a stave cooler for a metallurgical furnace, which is cost effective and provides a reliable stave cooler.

The method of manufacturing a stave cooler for a metallurgical furnace according to the present invention comprises supplying a metal plate having an inward side for facing the inside of the furnace and an opposite outward side, supplying at least one coolant pipe and establishing a thermo-conductive contact between the coolant pipe and the metal plate. According to an important aspect of the invention, the method further comprises providing the coolant pipe with a flattened face and externally fixing the flattened face to the metal plate on the outward side for establishing the thermo-conductive contact.

By virtue of one or several external coolant pipes, the required thickness of the plate can be drastically reduced when compared to the slabs used in traditional staves. As a result, significant savings in material cost and stave cooler weight are achieved. Furthermore, the coolant pipes are protected from the furnace interior, and in particular from a potential impact of charge material (burden). By virtue of the flattened face of the coolant pipes, a sufficient thermal transfer surface and consequently sufficient heat transfer is warranted.

In a preferred embodiment, the step of establishing the thermo-conductive contact comprises joining the flattened face to the outward side by means of a diffusion bonding process. By creating a diffusion layer, i.e. material continuity, between the pipes and the plate, the thermal conductance between both parts, and hence the overall cooling efficiency, is enhanced. The required thermal transfer surface between the plate and the pipes is reduced. The preferred diffusion bonding process is either a diffusion welding (DFW) process or a diffusion brazing (DFB) process.

The step of externally fixing the flattened face to the metal plate advantageously comprises lateral welding, preferably stitch or spot welding, of the coolant pipe to the outward side. In the latter embodiment, its is further preferable that the method comprises correlating the parameters of the welds and the pipe wall thickness of the coolant pipe such that the inward portion of the pipe wall is preserved unaffected by the welds. Welding the pipes to the plate for achieving a strong and durable mechanical fixation is considered complementary to diffusion bonding for enhancing the thermo-conductive contact, but may be omitted in case the diffusion joint also provides sufficient mechanical fixation.

The method may beneficially comprise providing a receiving groove in the metal plate on the outward side for partially sinking in the coolant pipe. Furthermore, the method may comprise supplying a metal plate that has a curved lateral cross-section in the step of supplying a metal plate. Alternatively, when the step of supplying a metal plate comprises supplying a flat metal plate, the method may further comprise the step of metal-forming the flat metal plate into a metal plate having a curved lateral cross-section.

In a preferred embodiment, the method may further comprise the steps of: supplying a one-piece rectangular copper plate, which has an even inward side and an even outward side and an initial thickness in the range of 10-150 mm, preferably 25-100 mm, as metal plate; machining anchorage grooves into the inward side for anchoring a refractory layer to the inward side; and the step of fixing the flattened face of the coolant pipe directly onto the even outward side or into the receiving groove.

As will be understood, the invention also concerns the stave cooler manufactured with the above method. It will be understood that this stave cooler is particularly adapted to be used in a cooling system of a metallurgical furnace such as a blast furnace.

### BRIEF DESCRIPTION OF THE DRAWINGS

Preferred methods of manufacturing a stave cooler for a metallurgical furnace and preferred stave coolers manufactured with these methods will now be described, by way of example, with reference to the accompanying drawings in which:

FIG. 1: is a lateral side view of a first stave cooler according to the invention;

FIG. 2: is an isometric a perspective view of an outward side of the stave cooler according to FIG. 1;

FIG. 3: is a lateral cross-sectional view of the stave cooler according to line III-III in FIG. 1;

FIG. 4: is a lateral cross-sectional view of a stave cooler according to a second embodiment invention;

FIG. 5: is a lateral cross-sectional view of a stave cooler according to a third embodiment of the invention.

In these drawings, similar or identical elements will be identified by identical reference numerals throughout. Further details and advantages of the present invention will be apparent from the following detailed description.

### DETAILED DESCRIPTION OF THE INVENTION

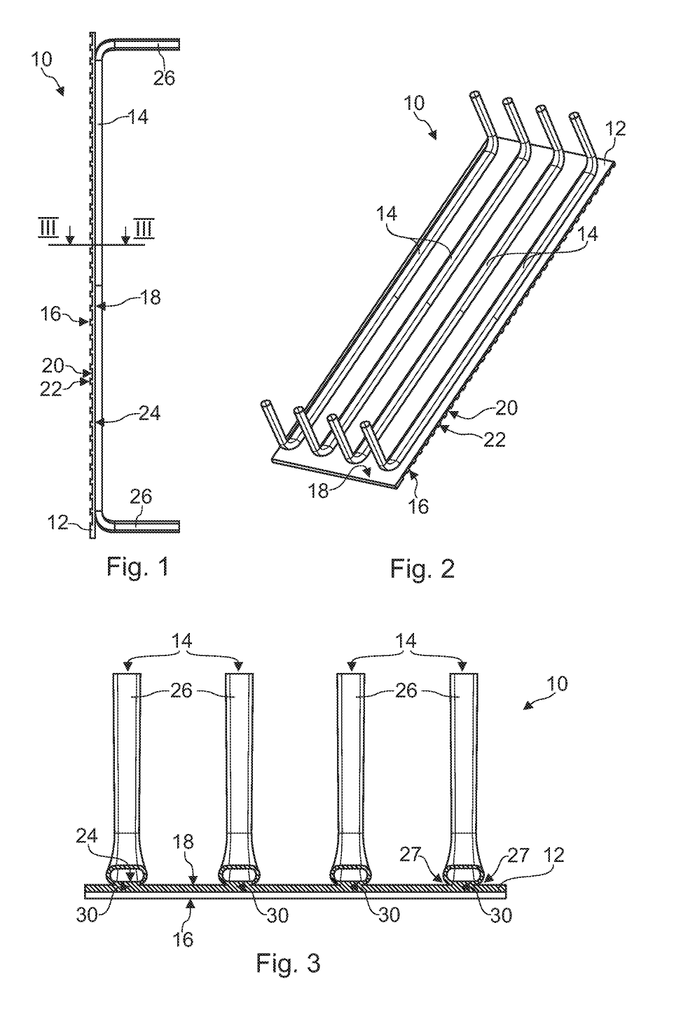

FIGS. 1-3 show a finished stave cooler, generally identified by reference numeral 10, to be arranged on the inside of the shell of a metallurgical furnace, in particular a blast furnace. The stave cooler 10 comprises a metal plate 12 and one or several, e.g. four, coolant pipes 14. As seen in FIG. 1 and FIG. 3, the metal plate has a first inward side 16 and an opposite second outward side 18. The inward side 16 faces the interior of a metallurgical furnace whereas the outward side 18 faces the furnace shell, when the stave cooler 10 is installed inside the furnace (not shown).

As seen in FIGS. 1-3, the metal plate 12 is manufactured from a comparatively thin flat rectangular plate having a length substantially exceeding the width and having a thickness in the range of 10-150 mm, preferably 25-100 mm. In preferred embodiments, the length of the metal plate 12 is chosen in the range of 400-4000 mm whereas the width is in the range of 100-1500 mm. When installed in the furnace, the metal plate 12 has its length extending in vertical direction. Although a rectangular metal plate 12 is shown in FIG. 1 and FIG. 2, its shape may be trapezoidal with the longitudinal sides tapering in order to adapt to conicity of the furnace shell where required. The metal plate 12 is preferably made of copper or a copper alloy. On the inward side 16, a plurality of parallel anchorage grooves 20 are machined into the metal plate 12 in lateral direction of the metal plate 12, so as to create an alternating pattern of anchorage grooves 20 and protrusions 22. The anchorage grooves 20 and protrusions 22 have a generally wedge shaped cross-section designed for increasing the cooling surface and anchoring a refractory layer, or an accretion layer in case the refractory is worn out, to the inward side 16 after the stave cooler 10 is installed.

In accordance with the present invention, the stave cooler 10 is not designed with internal channels for the coolant that are integral to the plate (normally cooling water), but with the coolant pipes 14, that form the channel for the coolant, fixed externally to the metal plate 12 on the outward side 18 as seen in FIGS. 1-5. As opposed to traditionally manufactured “staves”, it has been found that a fully circumferential thermal contact between the coolant channel and the metal plate 12 is not essential. The coolant pipes 14 are made of metal, preferably of copper, a copper alloy or steel. Furthermore, it is preferred to use seamless coolant pipes 14, so as to ensure that no welded joints that are critical to channel tightness are present inside the furnace. It should be noted that a first preferred combination comprises a metal plate 12 made of copper and seamless coolant pipes 14 made of copper. A second preferred combination comprises a metal plate 12 made of steel and seamless coolant pipes 14 made of steel.

As regards the manufacturing of the stave cooler 10, an efficient thermo-conductive contact needs to be established between the metal plate 12 and the coolant pipes 14. In order to establish this thermo-conductive contact in simple and cost-effective manner, the method of manufacturing comprises the step of providing each coolant pipe 14 with a flattened face 24 as seen in FIG. 3. This step can be achieved by any suitable metal-forming process to such as forging, rolling or pressing of conventional initially round pipes, while other processes are not excluded.

### EXAMPLE 1

Initial inner pipe diameter: 65-75 mm;
Flattened inner channel height after rolling: 20-50 mm.

### EXAMPLE 2

Initial inner pipe diameter: 30-45 mm;
Flattened inner channel height after rolling: 10-20 mm.

As seen in FIG. 3, the coolant pipes 14 are flattened on two sides, although only the flat face 24 is essential. The coolant pipes 14 hence have an oblong cross-section over the length which contacts the metal plate 12. Due to the flattened face 24, a thermal interface between the coolant pipes 14 and the flat outward side 18 of the metal plate 12 is obtained over a large portion of the surface of the pipe wall of the flattened coolant pipes 14.

As seen in FIG. 1 and FIG. 2, the coolant pipes 14 are flattened over a substantial length that approximately corresponds to the length of the metal plate 12. Furthermore, the coolant pipes 14 are bent so as to have a connection portion 26 at either upper and lower edge of the metal plate 12. The connection portions 26 extend from the plate 12 in outward direction after the coolant pipes 14 are fixed to the plate 12. The connecting portions 26 are at an angle to the metal plate 12 which depends on the installation location of the stave cooler 10. The initial length of the coolant pipes 14 is chosen such that, when the stave cooler 10 is installed, the connection portions 26 protrude out of the furnace shell in order to allow connecting the coolant pipes 14 to the cooling system of the furnace. To facilitate vertical stacking of stave coolers 10, there is no overhang of the connection portions 26 beyond the upper and lower edge of the metal plate 12. It may be noted that flattening of the coolant pipes 14 also facilitates bending the connection portions 26. With an uninterrupted homogenous pipe wall, the coolant pipes 14 provide a channel devoid of any (welded) joints inside the furnace, whereby problems related to thermal or mechanical wear of such (welded) joints are eliminated.

As indicated above, the manufacturing method further comprises fixing the flattened face 24 of each coolant pipe 14 externally to the metal plate 12 and more precisely to the outward side 18 thereof. As shown in FIG. 1 and FIG. 2, the coolant pipes 14 are fixed in parallel and lengthwise to the metal plate 12 with substantially equal interspace between the coolant pipes 14. The step of mechanically and permanently fixing the coolant pipes 14 to the outward side 18 can be carried out by welding the coolant pipes 14 to the metal plate 12 by means of several spot or stitch welds along the length of the coolant pipes 14 and located laterally of the flattened face 24. More precisely, the spot or stitch welds are located in the corners to the sides of the contacting surface between the metal plate 12 and the coolant pipes 14 as indicated by arrows 27. A few welds are generally sufficient to secure each coolant pipe 14 durably to the metal plate 12. Both, the weld parameters and the wall thickness of the coolant pipes 14 are chosen to ensure that the major inner part of the pipe wall remains unaffected at the locations of the stitch or spot welds. Hence, no full penetration welding is carried out.

In order to further improve the thermo-conductive contact between the metal plate 12 and the coolant pipes 14, i.e. between the flattened face 24 and the outward side 18, the manufacturing method preferably comprises the step of creating a diffusion layer 30 between the flattened face 24 and the outward side 18 by means of a diffusion bonding process. The diffusion layer 30 provides material continuity between the metal plate 12 and the flattened coolant pipes 14 and thereby warrants reliable and high thermal conductivity at their interface. In other words, the diffusion layer 30 represents a metal-to-metal joint which, by virtue of the used process, provides a continuous transition between the parent metal(s) without additional joining substance(s) forming the joint.

Depending on the material of the metal plate 12 and the coolant pipes 14, a filler material may or may not be used between the metal plate 12 and the coolant pipes 14 in order to provide the diffusion layer 30. When the respective materials are identical or similar, no filler material may be used. In the latter case the diffusion bonding process is considered diffusion welding (DFW). DWF is a solid-phase welding process which achieves coalescence of the adjacent surfaces by the application of pressure and elevated temperatures. Successful joining can be achieved at temperatures only slightly above half the melting temperature of the metals to be joined. Hence, the metallurgical properties of the metal parts to be joined remain substantially unaffected by the process. In case a filler material is used, the process is commonly called diffusion brazing (DFB). DFB is often used for joining dissimilar materials. Furthermore, DFB may be preferred over DFW because it has less stringent requirements on joint surface preparation and requires a lower pressure than that required for normal diffusion joining. It remains to be noted that creating the diffusion layers 30 by DFB or DFW is considered advantageous especially for a copper-cooper combination of the coolant pipes 14 and the metal plate 10 but not excluded for a steel-steel or other combination.

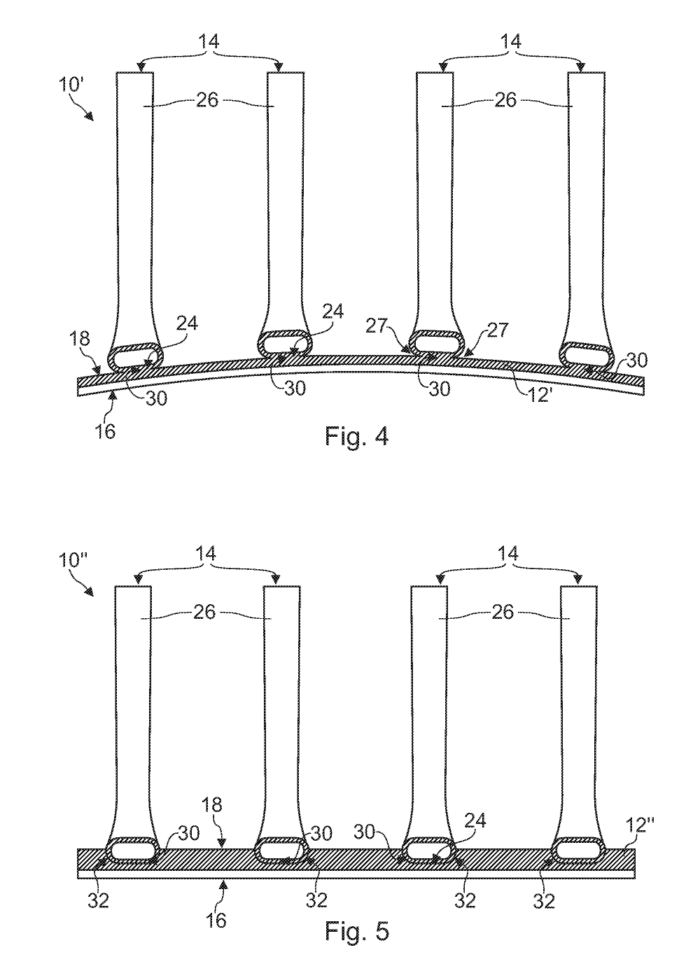

Further embodiments of finished stave coolers 10′, 10″ are shown in FIG. 4 and FIG. 5 respectively. Only the major differences compared to the previously described stave cooler 10 and its manufacturing method will be described below.

The stave cooler 10′ shown in FIG. 4 has a curved lateral cross-section. More precisely, the metal plate 12′ in FIG. 4 is bent in lateral direction. The radius of curvature of the metal plate 12′ is preferably constant and adapted to the radius of the circular furnace shell at the installation location in order to reduce the clearance between the furnace shell and the outward side 18 of the metal plate 12′. As a result, the useful inner volume of the furnace is increased. In order to confer the curved shape to the stave cooler 10′, its manufacturing process can comprise subjecting an initially flat metal plate to any suitable metal forming process, e.g. pressing, so as to provide the bent metal plate 12′. Alternatively, a metal plate that is initially curved as of manufacture may also be supplied. As will be appreciated, bending of an initially flat plate, independent of the process used, is facilitated due to the reduced thickness of the metal plate 12′ when compared to prior art stave coolers. During manufacturing, the coolant pipes 14 will normally be fixed to the outward side 18, only after the metal plate 12′ is curved.

Another embodiment of a stave cooler 10″ is shown in FIG. 5. When compared to the previous embodiments the metal plate 12″ is provided with a corresponding receiving groove 32 for each coolant pipe 14. Each receiving groove 32 extends in longitudinal direction over substantially the entire length of the outward side 18 of the metal plate 12″ and at least over the length of contact between the coolant pipes 14 and the metal plate 12″. By virtue of the receiving grooves 32, the flattened coolant pipes 14 of the stave cooler 10″ are partially sunk in, i.e. partially embedded, in the metal plate 12″ when they are fixed to the outward side 18. As appears from FIG. 5, the receiving grooves 32 have a substantially rectangular cross-section conjugated to the cross-section of the portion of the coolant pipes 14 that carries the flattened face 24. The receiving grooves 32 preferably have smooth rounded inside edges conforming to the cross-section of the coolant pipes 14. Compared to other shapes, such as semi-circular cross-sections, the receiving grooves 32 can be easily machined into the metal plate 12″, e.g. with custom milling tools during the manufacturing of the stave cooler 10″. The receiving grooves 32 allow increasing the thermal transfer surface to approximately half the outer surface of the coolant pipes 14 and allow improving the mechanical fixation of the coolant pipes 14 to the metal plate 12″. In addition, the clearance between the furnace shell and the outward side 18 of the metal plate 12″ can be further reduced.

Although not shown in the drawings, a stave cooler with the combined features of FIGS. 3, 4 and 5, i.e. diffusion layer, bent lateral cross-section of the plate and receiving grooves is considered as most preferred embodiment.

Other aspects of the stave cooler 10′ of FIG. 4 and the stave cooler 10″ of FIG. 5 and their respective manufacturing methods are identical or similar to those described above with respect to FIGS. 1-3.

Although not shown in the drawings, the metal plate 12 is normally provided with any suitable attachment contrivance for attaching the stave cooler 10 to the furnace shell.

Finally, some advantages resulting from the above described method remain to be recapitulated:
compared to the prior art, comparatively few assembly steps are required;
if any, only simple undemanding machining of the metal plate 12, 12′, 12″ and especially its flat outward side 18 is required for establishing the thermo-conductive contact between the coolant pipes 14 and the flat outward side 18;
no metal-forming of the metal plate 12, 12′, 12″ is required for establishing the thermo-conductive contact;
only an insignificant amount of scrap metal (chips) is produced with the described method due to the minimization of metal cutting;
no custom made pipes are required, available standard pipes can be used;
compared to prior art stave coolers, water pressure loss in the coolant channel is reduced due to the smooth bending of the coolant pipes 14;
with curved metal plates 12′, the useful inside volume of the blast furnace is optimised;
compared to stave coolers with integral(-ly cast) channels, separate coolant pipes 14 for the coolant channel provide an additional level of separation between the coolant and the furnace interior (additional barrier) thereby reducing leakage risks in case of cracks in the metal plate 12,12′, 12″.
   Because the metal plate 12, 12′, 12″ is made of a single part, i.e. as a one-piece component of the stave cooler 10:
it provides better protection of the coolant pipe(s);
it provides, at its inward side 16, a surface of substantially uniform temperature and hence reduces wear of the refractory layer related to temperature gradients;
it is available at comparatively low cost.
   In addition, since the stave cooler 10 does not comprise deep drilled or cast-in holes nor pipes inserted internally through the prior art stave coolers, the metal plate 12, 12′, 12″ used in manufacturing the stave cooler 10 has a drastically reduced thickness when compared to prior art staves. This thickness reduction enables:
considerable savings in material cost; and
a reduced weight load on the furnace shell supporting the stave coolers 10.

1.-12. (canceled)

13. A method of manufacturing a stave cooler for a metallurgical furnace comprising:
supplying a metal plate having an inward side for facing the inside of said furnace and an opposite outward side;
supplying at least one round coolant pipe;
providing said round coolant pipe with a flattened face; and
externally fixing said flattened face to said metal plate on said outward side for establishing a thermo-conductive contact between said coolant pipe and said metal plate.

14. The method according to claim 13, wherein fixing said flattened face to said metal plate comprises joining said flattened face to said outward side by means of a diffusion bonding process.

15. The method according to claim 14, wherein said diffusion bonding process is a diffusion welding process or a diffusion brazing process.

16. The method according to claim 13, wherein externally fixing said flattened face to said metal plate comprises lateral stitch welding or spot welding of said coolant pipe to said outward side.

17. The method according to claim 16, further comprising correlating the parameters of said lateral welding and the pipe wall thickness of said coolant pipe such that the inward portion of said pipe wall is preserved unaffected by said lateral welding.

18. The method according to claim 13, further comprising providing a receiving groove in said metal plate on said outward side for partially sinking in said coolant pipe, prior to establishing said thermo-conductive contact.

19. The method according to claim 13, comprising providing said round coolant pipe with a flattened face on two opposite sides such that said coolant pipe has an oblong cross-section over the length which contacts said metal plate.

20. The method according to claim 13, comprising supplying a one-piece copper plate, said one-piece rectangular copper plate having a thickness in the range of 25-100 mm.

21. The method according to claim 13, further comprising:
supplying a one-piece rectangular copper plate having an even inward side and an even outward side and an initial thickness in the range of 25-100 mm; and
machining anchorage grooves into said inward side for anchoring a refractory layer to said inward side;
wherein externally fixing said flattened face to said metal plate comprises fixing said flattened face of said coolant pipe directly onto said even outward side.

22. The method according to claim 13, further comprising:
supplying a one-piece rectangular copper plate having an even inward side and an even outward side and an initial thickness in the range of 25-100 mm;
machining anchorage grooves into said inward side for anchoring a refractory layer to said inward side; and
providing a receiving groove in said metal plate on said outward side for partially sinking in said coolant pipe;
wherein externally fixing said flattened face to said metal plate comprises fixing said flattened face of said coolant pipe into said receiving groove.

23. A method of manufacturing a stave cooler for a metallurgical furnace comprising:
supplying a metal plate having an inward side for facing the inside of said furnace and an opposite outward side;
supplying at least one round coolant pipe;
flattening said coolant pipe so as to provide said coolant pipe with a flattened face; and
externally fixing said flattened face to said metal plate on said outward side whereby a thermo-conductive contact between said coolant pipe and said metal plate is established.

24. The method according to claim 23, comprising flattening said coolant pipe over a length that substantially corresponds to the length of said metal plate.

25. A stave cooler for a metallurgical furnace comprising:
a metal plate having an inward side for facing the inside of said furnace and an opposite outward side; and
at least one coolant pipe having a flattened face fixed externally to said metal plate on said outward side so as to be in thermo-conductive contact with said metal plate.

26. The stave cooler according to claim 25, wherein said coolant pipe has a smooth rounded cross-section at least over the length which contacts said metal plate.

27. The stave cooler according to claim 25, further comprising a diffusion layer joining said flattened face and said outward side for establishing said thermo-conductive contact, said diffusion layer being provided by means of a diffusion welding process or by means of a diffusion brazing process.

28. The stave cooler according to claim 25, wherein said flattened face is fixed externally to said metal plate by means of lateral stitch welds or lateral spot welds.

29. The stave cooler according to claim 25, wherein said coolant pipe has two flattened faces provided on opposite sides and extending over the length which contacts said metal plate.

30. The stave cooler according to claim 25, wherein said metal plate is a one-piece rectangular copper plate.

31. The stave cooler according to claim 30, wherein said copper plate has a thickness in the range of 25-100 mm.

32. The stave cooler according to claim 30, wherein said copper plate has a receiving groove in said metal plate on said outward side for partially sinking in said coolant pipe and wherein said flattened face is fixed externally to said metal plate in said receiving groove.

33. The stave cooler according to claim 30, wherein said copper plate has an even outward side and wherein said flattened face of said coolant pipe is fixed directly onto said even outward side.

34. The stave cooler according to claim 30, wherein said copper plate has anchorage grooves machined into said inward side for anchoring a refractory layer to said inward side.

35. A metallurgical furnace, in particular a blast furnace, equipped with a cooling system, said cooling system including at least one stave cooler that comprises:
a metal plate having an inward side for facing the inside of said furnace and an opposite outward side; and
at least one coolant pipe having a flattened face fixed externally to said metal plate on said outward side so as to be in thermo-conductive contact with said metal plate.

36. The metallurgical furnace according to claim 35, wherein said coolant pipe has a smooth rounded cross-section at least over the length which contacts said metal plate.

37. The metallurgical furnace according to claim 35, wherein said stave cooler comprises a diffusion layer joining said flattened face and said outward side for establishing said thermo-conductive contact, said diffusion layer being provided by means of a diffusion welding process or by means of a diffusion brazing process.

38. The metallurgical furnace according to claim 35, wherein said metal plate is a one-piece rectangular copper plate that has a thickness in the range of 25-100 mm.

39. The metallurgical furnace according to claim 38, wherein said copper plate has a receiving groove in said metal plate on said outward side for partially sinking in said coolant pipe and wherein said flattened face is fixed externally to said metal plate in said receiving groove.

40. The metallurgical furnace according to claim 38, wherein said copper plate has an even outward side and wherein said flattened face of said coolant pipe is fixed directly onto said even outward side.

41. The metallurgical furnace according to claim 38, wherein said copper plate has anchorage grooves machined into said inward side for anchoring a refractory layer to said inward side.

42. The metallurgical furnace according to claim 38, wherein said metal plate has a curved lateral cross-section.
